(19) United States
(12) Patent Application Publication
(10) Pub. No.: US 2005/0043971 A1
(43) Pub. Date: Feb. 24, 2005

(54) Methods and system for insuring landscape architectural objects

(75) Inventors: C. Thomas Hendrickson, Zebulon, NC (US); William P. Glynn, Cary, NC (US); David L. Andrus, Boulder, CO (US); Gordon A. Reinert, Boulder, CO (US); David J. Argay, Cary, NC (US)

Correspondence Address: BURNS DOANE SWECKER & MATHIS L L P, POST OFFICE BOX 1404, ALEXANDRIA, VA, 22313-1404, US

(73) Assignee: Horticultural Asset Management, Inc.

(21) Appl. No.: 10/719,741

(22) Filed: Nov. 21, 2003

Related U.S. Application Data
(63) Continuation-in-part of application No. 10/642,865, filed on Aug. 18, 2003.

(51) Int. Cl. G06F 17/60

(52) U.S. Cl. 705/4

(57) ABSTRACT

Methods and a system are disclosed for insuring landscape architectural objects. According to an exemplary embodiment, a value associated with a landscape architectural object is determined. A change in the value of the object is determined over a period of time. A risk-of-loss to the object is determined attributable to an eligible event that can occur over the time period. A cost of an indemnity against a loss to the object is determined from the eligible event over the time period based on the change in value and the risk-of-loss.

### RELATED APPLICATIONS

This application is a continuation-in-part of copending U.S. patent application Ser. No. 10/642,865, filed on Aug. 18, 2003, and titled “Techniques for Valuing, Insuring, and Certifying a Valuation of Landscape Architectures”, the entire contents of which are incorporated here by reference.

### BACKGROUND

Landscape architectures are arrangements of landscape architectural objects (natural and/or structural) in a landscape architectural setting existing or developed for human use and enjoyment. A landscape architecture can include both an aesthetic component, e.g., the arrangement of the landscape architectural objects and/or the setting, and a physical component, e.g., the landscape architectural objects and the setting themselves. Landscape architectures not only greatly contribute to our environment and quality of life, but can add significant value to commercial and residential property.

Each year, billions of dollars are spent on developing landscape architectural settings in the United States for homes, businesses, parks, schools, streets, and the like. Yet much of this sizeable investment is left uninsured against loss or damage. Although standard homeowners and business insurance policies can provide some coverage against loss or damage to landscape architectural objects and/or settings, the amount of loss that can be recovered, and the types of perils and objects that are covered under these policies can all be limited.

For example, some homeowners policies can provide for the payment of a set maximum, say $250, per item lost or damaged from an insurable incident (or event). These types of policies also limit the total amount that can be paid, say $1000, per event. The recoverable losses under such policies can add up to only a small percentage of the total investment and/or value in a landscape setting that is completely lost to a catastrophic event, such as fire or a flood. In addition, the types of objects covered under homeowners policies can be limited to cover only trees, and perhaps shrubs, plants, and lawns. Other landscape objects, such as rock, mulch, ground covers, ponds, arbors, pergolas, fountains, planters, and the like can be excluded from coverage under the policies. Also, the perils covered under these policies typically exclude storms, wind, hurricanes, tornados, floods, hail, freezes, earthquakes, drought, contamination, pollution, disease, and pest (or insect) damage.

A cause for the limited coverage available for landscape architectural objects under current homeowners insurance policies is the absence of a consistent and reliable methodology for determining a value of the objects as included in the landscape architectural setting, or a value that the objects and the setting add or will add to the surrounding property. In general, to date, the valuation of landscape architectural objects and settings can be described more as an art rather than a science. Without standardized methods for determining the value of landscape architectural settings, insurance institutions can have little confidence in the values assigned to landscape architectural objects needed to indemnify the objects against loss.

For example, in each of the approximate twenty million appraisals that are performed annually in the United States in connection with the financing, purchasing, or insuring of real estate, a generally subjective and arbitrary value can be assigned to the landscape architectural settings associated with the real estate. Other methods of valuing landscape architectures focus only on a current cost of the landscape architectural objects. These methods can overlook an aggregate value contribution of the objects to a landscape architecture and a setting, and an appreciation in value that can occur as the objects mature in a landscape architectural setting.

Copending U.S. patent application Ser. No. 10/642,865 describes techniques for valuing, insuring, and certifying a valuation of landscape architectures. These techniques can not only be used to consistently and accurately assign a value to a landscape architectural object, but can also be used to reliably predict the change in the value of the landscape architectural object over a specified time period, such as the term of an insurance policy. This information can be used by insurance institutions to both determine the value of a landscape architectural object at the time a loss occurs, and to accurately estimate the future payout for insurance losses to particular landscape architectural objects. This, in turn can lead to the offering of new insurance products that can provide landscape owners with an objective replacement cost for lost landscape objects, rather than the limited and arbitrary settlement amounts that can be available with today's policies.

### SUMMARY

Accordingly, methods and a system are disclosed for insuring landscape architectural objects. According to an exemplary embodiment, a value associated with a landscape architectural object is determined. A change in the value of the object is determined over a period of time. A risk-of-loss to the object is determined attributable to an eligible event that can occur over the time period. A cost of an indemnity against a loss to the object is determined from the eligible event over the time period based on the change in value and the risk-of-loss.

According to another exemplary embodiment, a method of adjudicating a claim for a loss to a landscape architectural object includes determining prior to the loss a change in a value associated with the landscape architectural object over a period of time that includes the loss. A determination is made whether the loss is a total or partial loss to the object. An amount for the loss is paid based on a cost to replace the object when the loss is a total loss, and one of a cost to recondition the object and an amount of diminished value of the object when the loss is a partial loss. Each of the cost to replace the object, the cost to recondition the object, and the amount of diminished value of the object is based on at least one of a material cost of the object at the time of the loss, an installation cost of the object at the time of the loss, an appraised value based on an appraisal of the object at the time of the loss, and a calculated value based on the determined change in the value of the object over the period of time.

According to another exemplary embodiment, a system for insuring landscape architectural objects includes a data model and a processor coupled to the data model. The processor includes logic configured to determine a value associated with a landscape architectural object based on information included in the data model; logic configured to determine a change in the value of the object over a period of time based on information included in the data model; logic configured to determine a risk-of-loss to the object attributable to an eligible event that can occur over the time period based on information included in the data model; and logic configured to determine a cost of an indemnity against a loss to the object from the eligible event over the time period based on the change in value and the risk-of-loss.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method of insuring landscape architectural objects according to an exemplary embodiment;

FIG. 2 is a flowchart illustrating a method of adjudicating a claim for a loss to a landscape architectural object according to another exemplary embodiment;

FIG. 3 illustrates a system insuring landscape architectural objects according to an exemplary embodiment; and

FIG. 4 illustrates a system for adjudicating claims for the loss of the landscape architectural objects according to an exemplary embodiment.

### DETAILED DESCRIPTION

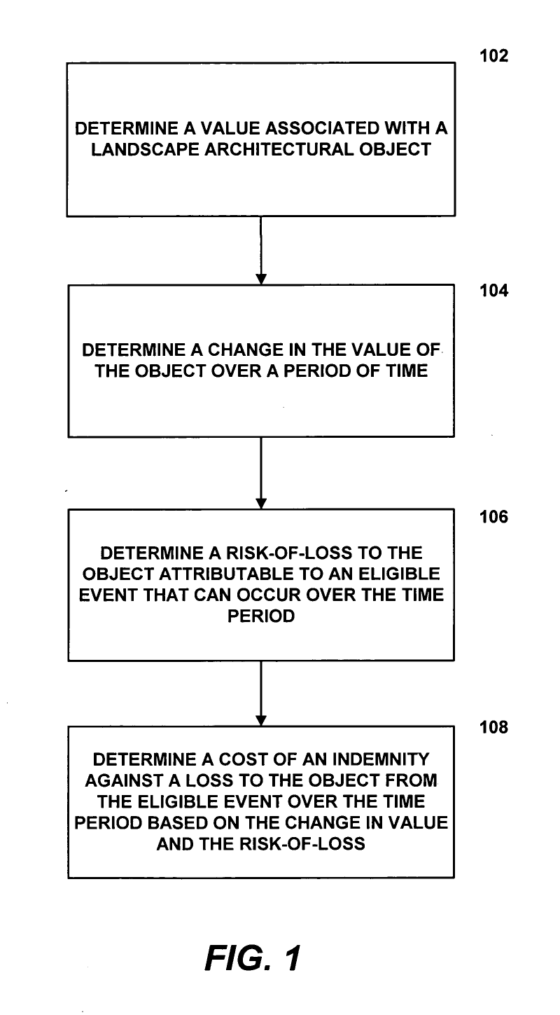

FIG. 1 is a flowchart illustrating a method of insuring landscape architectural objects. As used here, a “landscape architectural object” can broadly include both natural and structural objects. Examples of natural objects can include earth, rock, water, plantings, mulch, and the like. Water objects can include ponds, waterfalls, streams, marshes, and the like. “Plantings” can include any of a kingdom of living things typically lacking locomotive movement or obvious nervous or sensory organs and possessing cellulose cell walls. Examples of plantings can include trees, lawns, and plants.

Structural landscape architectural objects can include earth-related structures, such as berms, mounds, slopes, swells, earthen-planters, earthen-retaining walls, dry creek beds, and the like. Other structural objects can include enclosure structures, such as fences, edgings, and walls, shelter structures, such as a gazebo, garden houses, and pagodas, and other specialty buildings, such as arbors and pergolas. Other landscape architectural objects can include engineering structures, such as vehicular and pedestrian ways, decks, patios, pools, fountains, retaining walls, planters, and the like. Other structural objects can include engineering systems such as irrigation systems, lighting systems, and garden railroad systems. Structural landscape architectural objects can also include sculptural components, such as statues, sculptures, ornaments, and the like. Additional examples of structural objects can include outdoor furnishings, such as benches, gliders, and swings.

In block 102, a value associated with a landscape architectural object is determined. Techniques for determining a value associated with the landscape architectural object are described in detail in copending U.S. patent application Ser. No. 10/642,865, some of which are described below.

For example, according to an exemplary embodiment, the value associated with the landscape architectural object can be established by determining regional pricing information associated with at least one of a material cost of the landscape architectural object and an installation cost associated with an installing of the landscape architectural object in a landscape architectural setting. Pricing information associated with at least geographic region (e.g., a zip or postal code region) can be aggregated to determine the regional pricing information.

According to an exemplary embodiment, the regional pricing information can be based on at least one of retail regional pricing information and wholesale regional pricing information associated with at least one of the material cost and the installation cost. Wholesale pricing information can be used to exclude or de-emphasize artificially inflated retail pricing in a region. For example, when aggregating pricing information associated with at least geographic region, it can be necessary to account for artificially inflated retail pricing in regions that have only a small number of retail outlets for landscape architectural objects. Wholesale regional pricing information can be used to identify and account for these artificially inflated retail prices when determining the regional pricing information.

The regional pricing information can include labor costs associated with the installing of the landscape architectural object in the landscape architectural setting. These labor costs can be based on labor rates associated with contracting quotes, government publications, trade associations, industry publications, and affiliated labor contractors associated with the installing of the landscape architectural object in the landscape architectural setting. The regional pricing information can also include information describing a time and a cost per unit of time associated with the installing of the landscape architectural object in the landscape architectural setting.

The value of the landscape architectural object can also be influenced by aesthetic considerations. Accordingly, in another exemplary embodiment, a value associated with the landscape architectural object can be determined based on an aesthetic contribution of the object to a landscape architectural setting. The aesthetic contribution can be associated with the object and can include, among other things, a spacing, a mass, an alignment, a color, a lighting, a shading, a texture, and a scent of the object. The aesthetic contribution can also provide a thematic element to the landscape architectural setting, such as providing a unity and variety, a rhythm and balance, an accent and contrast, a scale and proportion, a dimensionality, and a spatiality to the setting.

In block 104, a change in the value of the object over a period of time is determined. The change in the value of the object can be defined in terms of a function that varies over the period depending on a number of factors. The period can be a lifespan of a landscape architectural object during which the object is insured against a loss, or can be a portion of the lifespan used to determine a cost associated with insuring the object during the portion. Once determined, the function defining the change in the value of the object can be used to calculate a value of the object at any time during the period in which a loss can occur. This information can be used to estimate the amount an insured would be paid for the loss, and can serve as a basis for providing replacement value insurance for landscape architectural objects.

Again, techniques for determining a change in the value of the object over a period of time, or a “future value” associated with the landscape architectural object, are described in detail in copending U.S. patent application Ser. No. 10/642,865, some of which are described below. For example, according to an exemplary embodiment, the change in the value of the object over the period of time can be established by determining a change in the material cost or the installation cost over the period. The change in the material cost or the installation cost over the period can be determined by adjusting the regional pricing information associated with the material cost or the installation cost over the period based on a macro-economic trend model.

The macro-economic trend model can be based on “NASDAQ” data, “RUSSELL 2000” data, thirty-year treasury bill data, consumer price index data, “DOW JONES” industrial average data, “STANDARD AND POOR'S” data, gold pricing data, five-year treasury bill data, inflation data, crude oil pricing data, unemployment data, federal reserve data, ten-year treasury bill data, and minimum wage data. The macro-economic trend model can be used to predict an increase in both the material cost associated with the landscape architectural object and the installation cost associated with the installing of the landscape architectural object in the landscape architectural setting due to inflation and other economic factors.

The change in the material cost associated with the landscape architectural object can also be based on at least one of a growth rate, a degradation rate, an appreciation rate, and a depreciation rate associated with the object over the time period. For example, a determination can be made that a crape myrtle tree having a height of three feet at the time of being insured can have a height of eight feet in five years based on a determined growth rate and associated growth curve. An initial material and installation cost associated with the three-foot crape myrtle tree can be determined based on regional pricing as described above. The macro-economic trend model can be used to adjust the initial material cost and installation cost associated with the three-foot crape myrtle tree. The adjusted cost can be used to determine the change in the value of the tree as it grows into an eight-foot specimen five years into the future.

The growth rate, the degradation rate, the appreciation rate, and the depreciation rate can be based on at least one of an attribute associated with the landscape architectural object and an attribute associated with the landscape architectural setting. Generally, growth rate is associated with natural objects, but both natural and structural object degrade, appreciate, and depreciate according to rates influenced by their attributes and surroundings. For example, natural objects, such as trees, can depreciate in value as they age and approach the end of their lifespan.

The attributes associated with the landscape architectural object that can affect these rates can include, among other things, a hardiness relative to a geographic location, a height, a maturity, a spread, a basal width, a container size, a lifespan, a soil adaptability, an anaerobic capacity, a pollution tolerance, an irrigation requirement, a sunlight requirement, a salinity tolerance, a shade tolerance, a drainage requirement, a shade-to-sun requirement, an urban tolerance, a form, a containerization tolerance, a temperature tolerance, a material type, a construction quality, a dimension, and a material finish.

The geographic location can correspond to one or more of the United States Department of Agriculture (USDA) plant hardiness zones. For example, a planting can have a slower growth rate when included in landscape architectural setting having an environment that differs from a recommended USDA hardiness zone for the planting. The lifespan associated with a natural landscape architectural object can be determined using an actuarial model configured to characterize and predict the life expectancy of the planting using statistical methods and data. The actuarial model can determine probabilities associated with the life expectancy of the natural object and integrate those probabilities with information regarding costs and rates of return to aid in determining the change in value of the landscape architectural object over the period.

The rates of growth, degradation, appreciation, and depreciation of the object can also be influenced by attributes of the landscape architectural setting. Setting attributes can include, among other things, a geographic location of the setting, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a soil type (e.g., clay, sand, rocky, and the like), a calcium carbonate (CaCO3) content, an urbanness, a land use type (e.g., residential, commercial, agriculture, and the like), a historic weather pattern, a moisture retention factor, an evapotranspiration rate, and a relative humidity. Setting attributes can again be general setting attributes or site-specific attributes.

As used here, “urbanness” refers to degree that the landscape architectural setting includes attributes relating to, characteristic of, or constituting a city. Setting attributes affecting the growth rate can be general setting attributes or site-specific attributes. Evapotranspiration rate represents the rate at which water is lost from the soil both by evaporation and by transpiration from the plants growing thereon.

According to an exemplary embodiment, the change in the value of the object over the period of time can be based on a property value trend model associated with a parcel of land including the landscape architectural object. The property value trend model can include a property sale price, such as house included on the parcel, an advertised property price, including comparable property on similarly situated parcels, an insured property value, a property type or zoning (e.g., residential, commercial, agriculture), a property grade, a lot size, a structure size, a property appraisal, and a property tax assessment value associated with the parcel of land.

In block 106 of FIG. 1, a risk-of-loss to the object is determined that is attributable to an eligible event that can occur over the time period. Like the change in the value of the object determined in block 104, the risk-of-loss can be defined in terms of a function that varies over the period depending on a number of factors. Once determined, the function defining the risk-of-loss can be used to calculate a risk (e.g., a probability) that value of the object at any time during the period in which a loss can occur. This information can be used to estimate the amount an insured would be paid for the loss, and can serve as a basis for providing replacement value, among other types of, insurance for landscape architectural objects. The actuarial model can be used to determine probabilities associated with the risk-of-loss to the object from the eligible event.

In the broadest sense, an “eligible event” as used-here can include any event that results in a loss to the landscape architectural object that is not attributable to an excluded cause of loss. Events resulting in a loss attributable to an excluded cause of loss are referred to here as “ineligible events”. For example, a flood can be an ineligible event if a planting is installed in a landscape architectural setting known to be included in a designated flood plane. Also, a lack of proper maintenance of an object, such as a draining of water from a sprinkler system before freezing, can be an “ineligible event”. A non-exhaustive list of eligible events includes a storm, a cyclone (or hurricane), a tornado, a flood, fire, hail, a freeze, an earthquake, lightning, explosion, drought, contamination, pollution, theft, disease, pest (or insect) damage, casualty events, and vandalism. Casualty events can include occurrences that result in vehicular (e.g., automobile, tractor, and the like) or aircraft damage to the landscape architectural object, construction-related events, and other collision or impact events.

According to an exemplary embodiment, the eligible event can be included in at least one of a plurality of event classes based on the determined risk-of-loss to the object attributable to the eligible event. For example, a first event class can include natural disasters, such as floods, fire, earthquakes, and the like, while a second event class can include events. While the frequency of such events is relatively low, the severity of the loss when such events occur is likely to be considerably high, resulting in an overall risk-of-loss associated with the class of events. Each class of events can be used to determine a cost of an indemnity against a loss to the object from an eligible event included in that class.

According to an exemplary embodiment, the risk-of-loss can be based on a susceptibility-of-loss to the landscape architectural object from the eligible event. The susceptibility-of-loss can be based on at least one of an attribute of the landscape architectural object and an attribute of a landscape architectural setting associated with the object. Attributes of the landscape architectural object affecting the susceptibility-of-loss can include at least one of a disease susceptibility, an insect damage susceptibility, a flood tolerance, a drought tolerance, a fire tolerance, a heat tolerance, a frost tolerance, a wind tolerance, an impact tolerance, a transplantability, a brittleness, a hardiness zone tolerance, and a hail tolerance. The actuarial model discussed above can be used to determine probabilities associated with the susceptibility-of-loss to the object from the eligible event.

Attributes of the landscape architectural setting affecting the susceptibility-of-loss can include at least one of an elevation, a grade, a stability, a drainage capacity, a proximity to standing or flowing water, an amount of natural or man-made shelter, an accessibility, a proximity to vehicular traffic, a proximity to air traffic, and a proximity to industrial property, a soil type, a density of plantings, a land use type, a historic weather pattern, and a geographic location.

The susceptibility-of-loss to the object can also be based on an aging of the landscape architectural object over the time period. The aging can be related to at least one of a growth rate and degradation rate associated with the landscape architectural object, and can act to either decrease or increase the susceptibility-of-loss depending on the eligible event. For example, if the eligible event is a tornado, an object with a lower growth rate can have a lower susceptibility of-loss to the tornado than an object with a higher growth rate. Conversely, an object with a lower growth rate can be more susceptible to fire than an object with a higher growth rate. For a structural object, the rate at which the object degrades can affect the object's susceptibility-of-loss to certain types of events. For example, a wooden structure that has dried-out and become more brittle with age can be more susceptible to damage in high winds than a corresponding newer structure.

The growth and degradation rates can be based on at least one of an attribute of the landscape architectural object and an attribute of a landscape architectural setting associated with the object. Attributes of the landscape architectural object and setting affecting the growth rate of the object are described above in conjunction with the determining a change in the value of the object over a period of time in block 104 of FIG. 1. Attributes of the landscape architectural object and setting affecting the degradation rate of the object are similar to the attributes described above affecting the depreciation rate when determining the change in the value of the object over a period of time.

According to another exemplary embodiment, the risk-of-loss can be based on at least one of frequency-of-loss and severity-of-loss information related to a prior loss from an event occurring before the eligible event and of an event type related to the eligible event. For example, consider a case where the risk-of-loss to a landscape architectural object from an eligible event, such as a wind storm, is to be determined. Historical information related to the frequency (or a number of occurrences) that the object or a similar object is damaged by a wind storm, and the severity of the loss (or amount of damage) resulting from each occurrence can be used to determine the risk-of-loss to the object from a wind storm. Frequency and severity-of-loss information from losses caused by events similar to the eligible event can be used as well. Thus, in the example above, historical information describing the severity-of-loss to the object from hurricanes having wind speeds similar to that of the wind storm of interest can be used to determine the risk-of-loss to object from the wind storm. The frequency-of-loss and severity-of-loss information can be determined using the actuarial model discussed above.

The prior loss can be associated with the landscape architectural object. For example, consider a case where an aspen tree is to be insured against loss. The prior loss on which the frequency-of-loss and severity-of-loss information can be based can include a loss to the to-be-insured aspen tree itself. The prior loss can also be another landscape architectural object included in a same landscape architectural setting as the aspen tree, e.g., an ash tree on the same parcel of land as the aspen tree. The prior loss used in determining the frequency-of-loss and severity-of-loss information can also be an object of an object type related to aspen tree, e.g., a second aspen tree or a tree having similar characteristics to the aspen tree. The prior loss can also be associated with a landscape architectural object having an attribute of the landscape architectural setting, e.g., a tree on a parcel of land having characteristics similar to the characteristics of the parcel of land including the aspen tree.

The prior loss can also be associated with property that is associated with the landscape architectural object. For purposes here, “property” refers to land and anything fixedly attached to land, such as houses, buildings, garages, and the like. This type of loss information can be of particular use in determining the frequency-of-loss from certain eligible events, and can be used to determine the severity-of-loss based on an amount of damage incurred by the property from the event. As discussed above, standard insurance policies covering landscaping and plants typically limit both the amount paid for each landscape architectural object lost to an particular event and for the total amount of loss from the event. This practice can skew the severity-of-loss information as the actual loss to the object is often greater than the limited amount paid for the loss. In contrast, severity-of-loss information associated with property is often more detailed. This information can be used to determine a severity-of-loss to an object associated with the property.

The prior property loss used in determining the frequency-of-loss and severity-of-loss information can be property included on a same parcel of land that includes the landscape architectural object. In the example of insuring an aspen tree introduced above, the property can be a house included on the same parcel of land on which the aspen tree is planted. The parcel of land can be residential land, commercial land, agricultural land, or the like. The property can also be adjoining the parcel of land, e.g., a claim for a loss to a neighboring house included on land adjoining parcel. The property can also be included in a same geographic zone as the parcel of land. The zone can be a neighborhood or zip code, or can defined on a larger scale, such as one of the USDA hardiness zones. The property having the prior loss can also be included on land having an attribute of the parcel of land that includes the landscape architectural object. Thus, a prior property loss on land at a similar elevation or having a similar climate or topology as the parcel that includes the aspen tree can be used in determining the frequency-of-loss and severity-of-loss information.

According to another exemplary embodiment, the risk-of-loss can be based on an event trend model. The event trend model can be used to predict the occurrence of particular events using historical event information. For example, the event trend model can include information related to at least one of a storm, a cyclone, a tornado, a flood, a fire, hail, a freeze, an earthquake, lightning, explosion, drought, soil contamination, theft, disease, insect damage, casualty events, and vandalism occurring prior to the eligible event. To predict the likelihood of an event affecting a particular landscape architectural object in a certain landscape architectural setting, the information included in the event trend model can be correlated with the landscape architectural setting that includes the landscape architectural object, a geographic zone (e.g., a USDA hardiness zone) including the landscape architectural setting, and a geographic location having an attribute (e.g., elevation, topology, and the like) of the landscape architectural setting. The actuarial model can be used to determine probabilities associated with the occurrence of particular events.

In addition to being used individually, various combinations of the susceptibility-of-loss, frequency-of-loss, severity-of-loss information, and event trend information can be combined to determine the risk-of-loss to the object from the eligible event.

In block 108 of FIG. 1, a cost of an indemnity against a loss to the object from the eligible event over the time period is determined based on the change in value and the risk-of-loss. As used here, “indemnity” refers to a guarantee of payment or a security provided against the loss to the object. According to an exemplary embodiment, the indemnity against the loss to the object can based on a cost to replace the object (a replacement cost) when the loss from the eligible event is a total loss, and one of a cost to recondition the object (a reconditioning cost) and an amount of diminished value of the object when the loss from the eligible event is a partial loss.

A total loss can occur when an object is irreparably damaged, when the damage to the object is such that the object can no longer sufficiently serve its intended purpose, or when the cost of such repair or reconditioning exceeds the value of the object just prior to the loss. A partial loss can occur when the object can be repaired or reconditioned to its value just prior to the loss and it is economically sound to do so, or when, despite the damage incurred, the object can continue to sufficiently serve its intended purpose.

According to an exemplary embodiment, the replacement cost, the reconditioning cost, and the amount of diminished value of the object can each be based on at least one of a material cost of the object at the time of the loss, an installation cost of the object at the time of the loss, an appraised value based on an appraisal of the object at the time of the loss, and a calculated value based on the determined change in the value of the object over the period of time.

The material cost plus the installation cost of the object at the time of the loss can be said to represent the “true” replacement cost of the object. The appraised value can be based on an appraisal of the object by a certified appraiser, who can objectively account for factors, such as disease, deterioration, enhanced aesthetic contribution, and the like, that can result in the appraised value of the object differing from the “true” replacement cost. Techniques for appraising and for provided certified appraisals of landscape architectural objects are described in detail in copending U.S. patent application Ser. No. 10/642,865. The calculated value can be based on the change in the value of the object over the period of time determined in block 104.

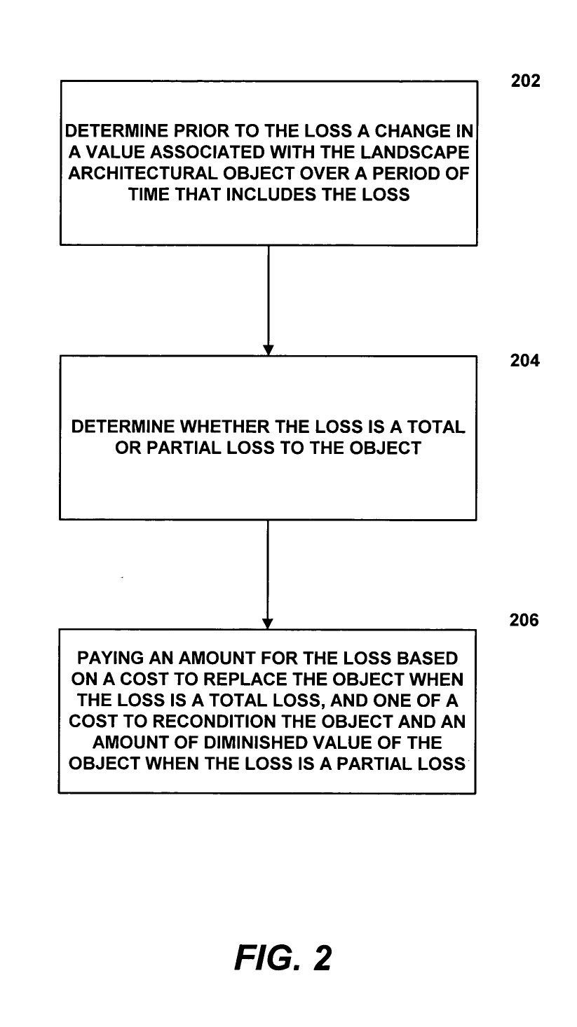

During the settlement (or adjudication) of a claim for the loss to a landscape architectural object, it is likely that a combination of the “true” replacement cost, the appraised value, and the calculated value will be used as the basis for paying for the loss to the object. Claims adjudication is described in detail below in conjunction with exemplary embodiment shown in FIG. 2

The indemnity can also be based on a percentage of one of the cost to replace the object, the cost to recondition the object, and the amount of diminished value of the object. In addition, the indemnity can be based on the percentage of one of the cost to replace the object, the cost to recondition the object, and the amount of diminished value of the object minus a deductible cost. The indemnity can also be based on an availability following an occurrence of the eligible event of at least one of a replacement for the object, labor to replace the object, and labor to recondition the object. For example, when a natural disaster, such as a hurricane or fire, occurs damaging or destroying large numbers of landscape architectural objects, small supplies of replacement objects and shortages of labor to repair and/or install those objects can lead to artificially inflated material and installation costs. The indemnity can be adjusted to account for these factors when determining the cost of the indemnity.

When the loss from the eligible event is a partial loss, the indemnity can be based on an amount of natural restoration of the object prior to a reconditioning of the object. For example, allowing a plant or tree to heal on its own can lead to an overall decreased cost of reconditioning the object to its value just prior to the loss. Similarly, an amount of expected natural restoration of the object can be used in determining the amount of the diminished value of the object resulting from the loss when it is not feasible or practical to repair or reconditioning the object.

According to an exemplary embodiment, the indemnity can be based on a value of property associated with the landscape architectural object. For example, the indemnity can be limited to a percentage of property included on a same parcel of land as the object. Thus, if the appraised value of a home is $250,000, a landscape insurance policy that limits the indemnity for loss to the landscape architectural objects on same parcel of land to ten percent of the property value would cap losses to landscape architectural objects on the parcel at $25,000.

The indemnity can also based on a total value of a plurality of landscape architectural objects as included in a landscape architectural setting associated with the object. Thus, a policy could limit the indemnity for a particular landscape architectural object to a percentage of the total appraised value of the landscaping including the object. In addition, the indemnity can be based on a total value of a plurality of landscape architectural objects of an object type related to the landscape architectural object as included in the landscape architectural setting. Accordingly, the indemnity for a particular tree can be limited to a percentage of the total value of all trees included in a landscape architectural setting. Similarly, the indemnity for a landscape lighting fixture can be limited by a total value of the landscape lighting system.

When the change in the value of object and the risk-of-loss to the object from eligible event are determined, the cost of the indemnity against the loss to the object from the eligible event over the time period can be based on equation (1) as follows:

$${C}_{I} = {\int }_{t = {t}_{1}}^{t = {t}_{2}} V ( t ) \times {R}_{E} ( t ) ⅆ t + {C}_{A} \qquad ( 1 )$$

In the above equation, C_{I} represents the cost of the indemnity against the loss to the object from the eligible event over the time period (t₂-t₁). The time period (t₂-t₁) can represent the entire period that the landscape architectural object is to be insured, or can represent a portion of the total period (or term) of the insurance. V(t) represents the change in the value of object over the period. R_{E}(t) represents the risk-of-loss to the object attributable to the eligible event E that can occur over the period. As discussed above, both the change in value of the object V(t) and the risk-of-loss to the object R(t) can be defined as time-varying functions, having changing values over the period of an insurance policy. The term “dt” in equation (1) represents a portion of the period, and will be understood by those familiar with integral calculus.

C_{A} in equation (1) represents a cost associated with administering the indemnity over the period. This cost can be a portion of the total cost to administer the indemnity based, e.g., on a total number of insured. The cost C, can represent a cost to underwrite the indemnity. A consumer cost of the indemnity C_{CI}, can include the cost of the indemnity C_{I} plus a cost associated with marketing the indemnity C_{MI}.

According to an exemplary embodiment, the consumer cost of the indemnity C_{CI} can be based on an implementation of a developmental program associated with a development of the landscape architectural object in a landscape architectural setting. Such a developmental program can help to ensure that the landscape architectural objects are cared for and maintained so as to reduce the likelihood that a loss will occur over the insured period. While the implementation of a developmental program can be a requirement for insuring all landscape architectural objects, for certain landscape objects, such as high-risk, high-cost, rare, and irreplaceable objects, the implementation of a developmental program can be the only means of obtaining and maintaining insurance against the loss to the object. The design and implementation of developmental programs are described in detail in copending U.S. patent application Ser. No. 10/642,865.

The developmental program can address a disease susceptibility, an insect damage susceptibility, a flood tolerance, a drought tolerance, a fire tolerance, a heat tolerance, a frost tolerance, a wind tolerance, an impact tolerance, a transplantability, a brittleness, a hail tolerance, a hardiness relative to a geographic location, a height, a maturity, a spread, a basal width, a container size, a lifespan, a soil adaptability, an anaerobic capacity, a pollution tolerance, an irrigation requirement, a sunlight requirement, a salinity tolerance, a shade tolerance, a drainage requirement, a shade-to-sun requirement, an urban tolerance, a form, and a maintenance of the landscape architectural object.

The developmental program can also address an elevation, a grade, a stability, a drainage capacity, a proximity to standing or flowing water, an amount of natural or man-made shelter, an accessibility, a proximity to vehicular traffic, a proximity to air traffic, and a proximity to industrial property, a soil type, a density of plantings, a geographic location of the setting, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a soil type, a calcium carbonate (CaCO3) content, an urbanness, a moisture retention factor, an evapotranspiration rate, a relative humidity, and a maintenance of the landscape architectural setting.

It will be understood that equation (1) can be used to determine the cost of an indemnity against a loss to a landscape architectural object from one type of event. The cost associated with indemnifying all of the landscape architectural objects included in a landscape architectural setting can be calculated by first summing the integral of equation (1) across all risks-of-loss to the various event types indemnified for each landscape architectural object, and then adding the individually calculated costs for each landscape architectural object together to reach the total indemnification cost for the landscape architectural setting and its objects.

FIG. 2 is a flowchart illustrating a method of adjudicating a claim for a loss to a landscape architectural object according to an exemplary embodiment. In block 202, a determination is made prior to the loss of a change in a value associated with the landscape architectural object over a period of time that includes the loss. Techniques for determining the value of a landscape architectural object and the change in that value over the period of time are described above in conjunction with blocks 102 and 104 of the exemplary embodiment shown in FIG. 1. Such techniques are also described in detail in copending U.S. patent application Ser. No. 10/642,865.

Next, in block 204, a determination is made whether the loss is a total or partial loss to the object. As discussed above, a total loss can occur when an object is irreparably damaged, when the damage to the object is such that the object can no longer sufficiently serve its intended purpose, or when the cost of such repair or reconditioning exceeds the value of the object just prior to the loss. A partial loss can occur when the object can be repaired or reconditioned to its value just prior to the loss and it is economically sound to do so, or when, despite the damage incurred, the object can continue to sufficiently serve its intended purpose.

In block 206, an amount is paid for the loss based on a cost to replace the object when the loss is a total loss, and one of a cost to recondition the object and an amount of diminished value of the object when the loss is a partial loss. Each of the cost to replace the object, the cost to recondition the object, and the amount of diminished value of the object is based on at least one of a material cost of the object at the time of the loss, an installation cost of the object at the time of the loss, an appraised value based on an appraisal of the object at the time of the loss, and a calculated value based on the determined change in the value of the object over the period of time.

When the loss is a total loss, an amount is paid based on the cost to replace the object. As discussed above, the material cost plus the installation cost of the object at the time of the loss can represent the “true” replacement cost of the object. The appraised value can be based on an appraisal of the object by a certified appraiser, who can objectively account for factors, such as disease, deterioration, enhanced aesthetic contribution, and the like, that can result in the appraised value of the object differing from the “true” replacement cost. The calculated value can be based on the change in the value of the object over the period of time determined in block 202.

During the settlement (or adjudication) of a claim for the loss to a landscape architectural object, it is likely that a combination of the “true” replacement cost, the appraised value, and the calculated value will be used as the basis for paying for the loss to the object. For example, consider a case where an aspen tree is lost from a lightning strike and subsequent fire. The tree lost was the third in a row of five trees planted accentuate the driveway approach to a home. The aspen tree had been insured against loss for its cost of replacement during a period of ten years from the time the tree was planted in its landscape architectural setting. At the time of its planting, the tree had a material cost of $100 and an installation cost of $25. The loss occurred five years after the tree was planted.

At the time of the loss, the material cost of a replacement for the five-year-old tree is $310 and the installation cost is $50. These costs can be determined using a real-time pricing model as described in detail in copending U.S. patent application Ser. No. 10/642,865. An appraisal of the tree determines the replacement value of the tree to be $450, including installation costs. The appraisal includes added compensation to account for aesthetic contribution (and subsequent loss) of the tree to the row of five aspen trees. The change in the value of the aspen tree calculated in block 202 using the techniques described above yields a value of $475, including installation costs. Depending on the terms of the policy and other factors, such as the availability of a replacement, the insured can be paid any one of the above sums for the loss to the tree, or can be paid an amount based on one or more these sums.

When the loss is a partial loss, an amount is paid based on least one of the cost to recondition the object and the amount of diminished value of the object. Each of these amounts is based on at least one of the material cost of the object at the time of the loss, the appraised value of the object at the time of the loss, and the calculated value based on the determined change in the value of the object over the period of time. The actual payment made to recondition the object or to reimburse the insured for the amount of diminished value can be based on a combination of the material cost, the appraised value, and the calculated value of the object over the period depending on terms in the insurance policy and other factors, such as the feasibility of reconditioning the object.

Accordingly, consider in the example above that the aspen tree was struck by lighting but that the ensuing fire did not occur destroying the tree. Instead, only a single limb of the tree was significantly damaged by the lighting strike. The material cost, the appraised value, and the calculated value of the object are the same as in the above example. Conditioning the tree can involve removing the damaged limb, applying tree salve and nutrients to aid in the reconditioning, and instituting a limited period of monitoring the tree to ensure the reconditioning progresses satisfactorily. The cost of this reconditioning can be $250. In addition, an appraisal of the damaged tree can determine that the amount of diminished value of the tree as a result of the damage is $100. Consequently, depending on the terms of the policy, the insured can be paid $350 for the loss. If the cost of reconditioning and/or the amount of diminished value exceeds the value of the tree (e.g., $475), then the loss can be deemed a total loss, and the determined value (e.g., $475) paid to the insured for the loss.

According to an exemplary embodiment, a percentage of one of the cost to replace the object, the cost to recondition the object, and the amount of diminished value of the object can be paid for the loss. In addition, the percentage of the one of the cost to replace the object, the cost to recondition the object, and the amount of diminished value of the object minus a deductible cost can be paid for the loss. Thus, in example above, were the loss to be deemed a total loss, the insured can be paid ninety percent of the loss, minus a $100 deductible to yield a final paid amount of $327.50. The percentage and/or deductible amount can be terms of the insurance policy covering the landscape architectural object.

The amount paid for the loss can be based on an availability following the loss of at least one of a replacement for the object, labor to replace the object, and labor to recondition the object. Thus, consider in the above example that the loss is deemed to be a total loss, but because of limited supply of replacement aspen trees in the area, the material and/or installation costs determined, e.g., using the real-time pricing model discussed above, may not reflect the current supply shortage of aspen trees. Under such circumstances, the indemnity can be adjusted to account for any added cost resulting from the shortage. Certain types of events, such as natural disasters, will most likely cause such shortages, and thus these added costs can be incorporated into the up-front cost of providing an indemnity against the loss to an object from the events. Conditions of an insurance policy can require that the insured wait a predetermined period of time before being compensated for a loss until such shortages of replacement objects and/or labor subside.

When the loss is a partial loss, the amount paid for the loss can be based on an amount of natural restoration of the object prior to a reconditioning of the object. For example, allowing a plant or tree to heal on its own can lead to an overall decreased cost of reconditioning the object to its value just prior to the loss. Similarly, an amount of expected natural restoration of the object can be used in determining the amount of the diminished value of the object resulting from the loss when it is not feasible or practical to repair or reconditioning the object.

As described above, the amount paid for the loss can also be based on a value of property associated with the landscape architectural object, a total value of a plurality of landscape architectural objects as included in a landscape architectural setting associated with the object, or a total value of a plurality of landscape architectural objects of an object type related to the landscape architectural object as included in the landscape architectural setting. These techniques can be used to place limits or caps on the amount paid for the loss to certain landscape architectural objects.

According to an exemplary embodiment, an appraiser can be sent or dispatched to a location of the loss to determine whether the loss is a total loss or partial loss to the object. The appraiser can be certified to generated a certified landscape architectural object appraisal report for the damaged object in the manner described in detail in copending U.S. patent application Ser. No. 10/642,865. Information can be made available to the appraiser to determine the amount of the loss including, among other things, the material cost of the object at the time of the loss, the installation cost of the object at the time of the loss, the cost to recondition the object at the time of the loss, the appraised value of the value of the object at the time of the loss, the amount of diminished value of the object from the loss, and the calculated value of the object based on the change in the value associated with the object over the period of time.

The information made available to the appraiser can be included in published guidelines, or can stored in a centralized database that can be accessed via terminals and/or personal communication devices, such as a personal data assistant (PDA), to determine the amount of loss and/or the amount of payment to be made for the loss. The appraiser can also have access to inventory information related to the damaged landscape architectural object and repair and/or labor contractors to effect a reconditioning or repair of the object from the loss.

During an appraisal, standards for valuing and inspecting the landscape—architectural object can be identified, and a certified appraisal and certified inspection report associated with the landscape architectural object can be created based on the identified standards for valuing and inspecting, respectively. The appraiser can be certified to determine at least one of the cost to recondition the object at the time of the loss, the appraised value of the object at the time of the loss, the amount of diminished value of the object from the loss, and the calculated value of the object based on the change in the value associated with the object over the period of time based on the certified appraisal and certified inspection report.

According to an exemplary embodiment, a claim for the loss of the landscape architectural object can be received. The claim can be received by the insurer from the insured via mail, telephone, or computer, e.g., through a secure network connection. Once received, a settlement for the loss can be offered based on at least one of the material cost of the object at the time of the loss, the installation cost of the object at the time of the loss, and the calculated value based on the determined change in the value of the object over the period of time.

For example, when the claim is received via a computer through a secure network connection, the material and installation costs of the object can be determined, e.g., using the real-time pricing model discussed above. In addition, the computer can be used determine the calculated value of the object based on the change in value of the object over the period. The settlement can based on a greater of the material cost plus the installation cost and the calculated value based on the determined change in the value of the object over the period of time. Alternatively, the settlement can be based on other factors, such as the terms of the insurance policy covering the object.

When the settlement offered is accepted, e.g., by the insured, the settlement offered can be paid for the loss. This method of claims adjudication has the advantages of convenience and timeliness of receiving payment for the insured, and predictability and efficiency of settling claims for the insurer. Regarding the latter advantages to the insured, the calculated value based on the determined change in value of the object over the period that can be offered as a basis for the settlement, can also be used to determine the cost of the indemnity paid by the insured against the loss. Sufficient pricing can be added to the calculated value at the time the cost of the indemnity is determined to cover expenses and desired profit. In addition, this “automatic” method of claims adjudication avoids having to send an appraiser to determine the amount to be paid to settle a claim. When, however, the settlement offered is rejected by the insured, an appraiser can be sent to a location of the loss to determine at least one of the cost to replace the object, the cost to recondition the object, and the amount of diminished value of the object to settle the loss.

It will be understood that use of the above-described “automatic” method of claims adjudication can require an insurer to incur risk associated with the filing of false claims of loss. Consequently, this method of claims adjudication can be used when the veracity of a claim is high, e.g., as determined by the details of the claim describing the loss. The “automatic” method can also be used when natural disasters occur, such as a hurricane, as the number of claims following such disasters, as well as the likelihood that those claims are true will both be high. In situations where the veracity of a claim for a loss is questionable, an appraiser can be sent to a location of the loss to determine the veracity of the claim.

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both.

Thus, the various aspects can be embodied in many different forms, and all such forms are contemplated to be within the scope of what is described. For each of the various aspects, any such form of embodiment can be referred to here as “logic configured to” perform, or “logic that” performs a described action.

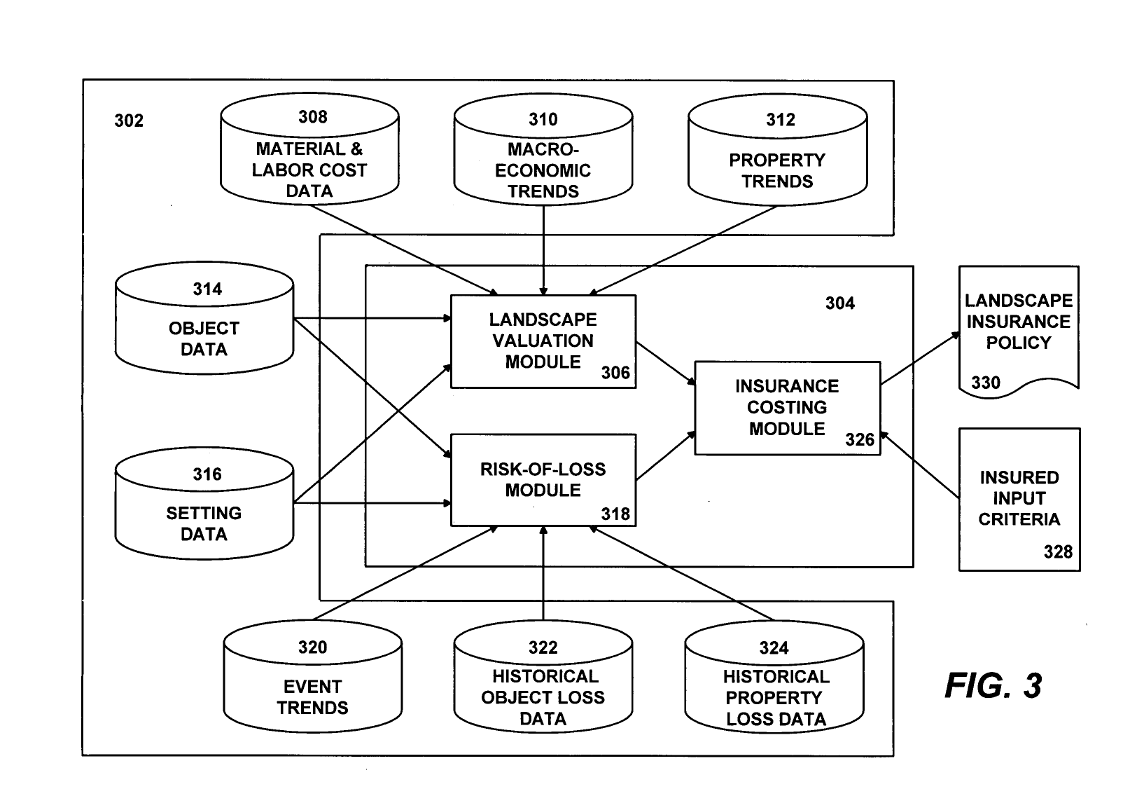

A system for insuring landscape architectural objects according to an exemplary embodiment is shown in FIG. 3. The system includes means for insuring landscape architectural objects such as a data model 302 and a processor 306 as shown in the figure. Input criteria 328, such as a listing of objects to be insured and a desired term of insurance, can be gathered from the insured, and a landscape insurance policy 330 can be generated using the system.

The processor 304 includes logic configured to determine a value associated with a landscape architectural object based on information included in the data model 302. For example, a landscape valuation module 306 included in the processor 304 can be coupled to a database 308 of the data model 302 including material cost and installation cost (including labor and equipment costs) associated with the landscape architectural object. This information can be used by the landscape valuation module 306 to determine regional pricing information associated with at least one of an initial material cost of the landscape architectural object and an initial installation cost associated with an installing of the landscape architectural object in a landscape architectural setting included in the data model 302.

The processor 304 also includes logic configured to determine a change in the value of the object over a period of time based on information included in the data model 302. For example, the landscape valuation module 306 can also include logic configured to determine a change over the period in the regional pricing information associated with at least one of the initial material cost and the initial installation cost determined prior to the loss using the material and labor cost database 308. To determine the change in the value of the object, the landscape valuation module 306 can include logic configured to adjust the regional-pricing information associated with at least one of the initial material cost and the initial installation cost determined prior to the loss. The regional pricing information can be adjusted using data included in a macro-economic trend model 310, and a property value trend model 312 included in the data model 302.

According to an exemplary embodiment, the logic configured to determine the change in the value of the object over the period of time can also include logic configured to determine at least one of a growth rate, a degradation rate, an appreciation rate, and a depreciation rate associated with the object over the time period. The growth rate, the degradation rate, the appreciation rate, and the depreciation rate can be based on at least one of an attribute associated with the landscape architectural object and an attribute associated with the landscape architectural setting included in the data model 302.

For example, the landscape valuation module 306 can be coupled to an object database 314 and a setting database 316 that include attributes of the object and setting, respectively, that can be used to determine the growth and degradation rates of the object. The material and labor cost database 308, macro-economic trend model 310 and property value trend model 312 can be used together with the object and setting databases 314, 316 to determine the appreciation and depreciation rates of the object.

The processor 304 also includes logic configured to determine a risk-of-loss to the object attributable to an eligible event that can occur over the time period based on information included in the data model 302. For example, a risk-of-loss module 318 can be included in the processor 304 that can include logic configured to determine a susceptibility-of-loss to the landscape architectural object from the eligible event. The susceptibility-of-loss can be based on at least one of an attribute of the landscape architectural object included in the object database 314 and an attribute of a landscape architectural setting associated with the object included in the setting database 316 of the data model 302.

The logic configured to determine the susceptibility-of-loss can include logic configured to determine at least one of a growth rate and a degradation rate associated with the landscape architectural object based on at least one of the attribute of the landscape architectural object and the attribute of a landscape architectural setting associated with the object included in the data model 302. The risk-of-loss-module-318 can be coupled to the object database 314 and the setting database 316 that include attributes of the object and setting, respectively, that can be used to determine the growth and degradation rates of the object. The material and labor cost database 308, macro-economic trend model 310 and property value trend model 312 can be used together with the object and setting databases 314, 316 to determine the appreciation and depreciation rates of the object.

According to an exemplary embodiment, the risk-of-loss to the object can be based on at least one of frequency-of-loss information related to a prior loss from an event occurring before the eligible event and of an event type related to the eligible event, severity-of-loss information related to the prior loss, and an event trend model included in the data model 302. The frequency-of-loss and severity-of-loss information related to the prior loss can be associated with at least one of the landscape architectural object and property associated with the object. For example, the risk-of-loss module 318 can be coupled to an object loss database 322 and a property loss database 324 that each include historical loss (e.g., claim) information for determining the frequency-of-loss and severity-of-loss of the landscape architectural object.

The processor 304 also includes logic configured to determine a cost of an indemnity against a loss to the object from the eligible event over the time period based on the change in value and the risk-of-loss. For example, an insurance costing module 326 can be used to determine the cost of the indemnity based on the insured input criteria 328 and information from the landscape valuation module 306 and the risk-of-loss module 318, e.g. by computing the relationship described in equation (1).

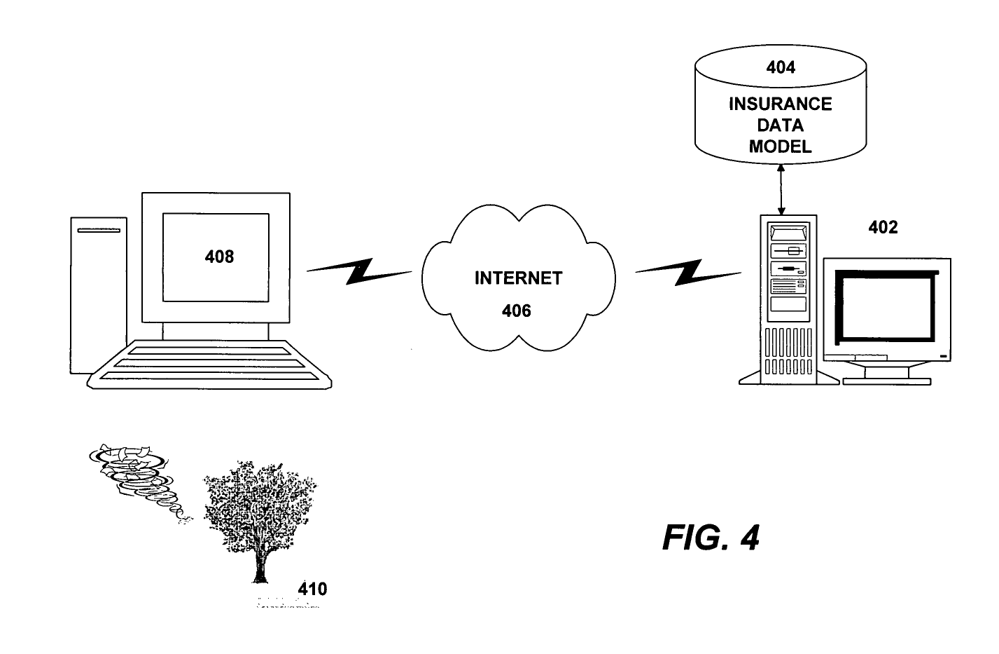

According to an exemplary embodiment, the system can include logic configured to receive a claim for the loss of the landscape architectural object. For example, in FIG. 4, a computer/server 402 can include the processor 304 described above in conjunction with FIG. 3. The computer/server 402 can be coupled to an insurance data model 404 including the databases of the data model 302 shown in FIG. 3. The claim can be generated, e.g., by the insured, via an input/output (I/O) device, such as the personal computer (PC) 408 shown in the figure, or a personal data assistant (PDA). Alternatively, the claim can be sent by mail or telephone. The computer/server 402 can be operatively coupled to the I/O device 408 via a network 406, such as the Internet, for receiving the claim.

The system can include logic configured to determine whether the loss is a total or partial loss to the object based on information included in the claim and information included in the insurance data model 404. Additional logic can be configured in the system to offer a settlement for the loss based on at least one of a cost to replace the object when the loss is a total loss, and one of a cost to recondition the object and an amount of diminished value of the object when the loss is a partial loss. The settlement offer can be sent to the insured via the network connection between the computer/server 402 and the I/O device 408 over the network 406. The network connection can be a secure network connection, such as via an HTTPS protocol.

Logic can be configured in the system to pay the settlement for the loss when the settlement offered is accepted. For example, a depositing of funds can be made into the insured's bank account. Additional logic can be configured in the system to dispatch an appraiser to a location 410 of the loss to determine at least one of the cost to replace the object, the cost to recondition the object, and the amount of diminished value of the object when the settlement offered is rejected. In addition, the system can include logic configured to determine a veracity of the claim based the information included in the claim. Additional logic can be configured to dispatch an appraiser to a location of the loss to verify whether the loss to the object is a total or partial loss when the veracity of the claim is uncertain. For example, consider a situation where a claim for the loss of an object indicates that the object was damaged or lost as the result of a wind gust. The system can be coupled to databases (not shown) describing the weather conditions at a location and time of the loss. If these databases do not indicate that a wind gust of the reported magnitude occurred near the time of the loss, an appraiser can be sent to the location to verify the loss of the object.

The instructions of a computer program as illustrated in FIG. 1 for insuring landscape architectural objects can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method of insuring landscape architectural objects, the method comprising:
determining a value associated with a landscape architectural object;
determining a change in the value of the object over a period of time;
determining a risk-of-loss to the object attributable to an eligible event that can occur over the time period; and
determining a cost of an indemnity against a loss to the object from the eligible event over the time period based on the change in value and the risk-of-loss.

2. The method of claim 1, wherein the risk-of-loss is based on a susceptibility-of-loss to the landscape architectural object from the eligible event.

3. The method of claim 2, wherein the susceptibility-of-loss is based on at least one of an attribute of the landscape architectural object and an attribute of a landscape architectural setting associated with the object.

4. The method of claim 3, wherein the attribute of the landscape architectural object comprises at least one of a disease susceptibility, an insect damage susceptibility, a flood tolerance, a drought tolerance, a fire tolerance, a heat tolerance, a frost tolerance, a wind tolerance, an impact tolerance, a transplantability, a brittleness, a hardiness zone tolerance, and a hail tolerance.

5. The method of claim 3, wherein the attribute of the landscape architectural setting comprises at least one of an elevation, a grade, a stability, a drainage capacity, a proximity to standing or flowing water, an amount of natural or man-made shelter, an accessibility, a proximity to vehicular traffic, a proximity to air traffic, a proximity to industrial property, a soil type, a density of plantings, a land use type, a historic weather pattern, and a geographic location.

6. The method of claim 2, wherein the susceptibility-of-loss is based on an aging of the landscape architectural object over the time period.

7. The method of claim 6, wherein the aging is related to at least one of a growth rate and a degradation rate associated with the landscape architectural object.

8. The method of claim 7, wherein the at least one of the growth rate and the degradation rate is based on at least one of an attribute of the landscape architectural object and an attribute of a landscape architectural setting associated with the object.

9. The method of claim 8, wherein the attribute of the landscape architectural object comprises at least one of a hardiness relative to a geographic location, a height, a maturity, a spread, a basal width, a container size, a lifespan, a soil adaptability, an anaerobic capacity, a pollution tolerance, an irrigation requirement, a sunlight requirement, a salinity tolerance, a shade tolerance, a drainage requirement, a shade-to-sun requirement, an urban tolerance, a form, a containerization tolerance, a temperature tolerance, a material type, a construction quality, a dimension, and a material finish.

10. The method of claim 8, wherein the attribute of the landscape architectural setting comprises at least one of a geographic location of the setting, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a soil type, a calcium carbonate (CaCO3) content, an urbanness, a land use type, a historic weather pattern, a moisture retention factor an evapotranspiration rate, and a relative humidity.

11. The method of claim 1, wherein the risk-of-loss is based on at least one of frequency-of-loss and severity-of-loss information related to a prior loss from an event occurring before the eligible event and of an event type related to the eligible event.

12. The method of claim 11, wherein the prior loss is associated with at least one of the landscape architectural object and property associated with the object.

13. The method of claim 12, wherein the prior loss associated with the landscape architectural object is a prior loss to at least one of the object, a second object included in a same landscape architectural setting as the object, a third object of an object type related to landscape architectural object, and a fourth object included in an environment having an attribute of the landscape architectural setting.

14. The method of claim 12, wherein the prior loss associated with the property is a prior loss to at least one of property included on a same parcel of land including the landscape architectural object, property adjoining the parcel of land, property in a same geographic zone as the parcel of land, and property included on land having an attribute of the parcel of land.

15. The method of claim 14, wherein the parcel of land is at least one of residential land, commercial land, and agricultural land.

16. The method of claim 1, wherein the risk-of-loss to the object from the eligible event is based on an event trend model.

17. The method of claim 16, wherein the event trend model includes information related to at least one of a storm, a cyclone, a tornado, a flood, a fire, hail, a freeze, an earthquake, lightning, explosion, drought, soil contamination, theft, disease, insect damage, casualty events, and vandalism occurring prior to the eligible event.

18. The method of claim 16, wherein the information included in the event trend model is correlated with at least one of a landscape architectural setting including the landscape architectural object, a geographic-zone including the landscape architectural setting, and a geographic location having an attribute of the landscape architectural setting.

19. The method of claim 1, wherein the risk-of-loss is based on at least one of a susceptibility-of-loss to the landscape architectural object from the eligible event, frequency-of-loss information related to a prior loss from an event occurring before the eligible event and of an event type related to the eligible event, severity-of-loss information related to the prior loss, and an event trend model.

20. The method of claim 1, wherein the eligible event includes at least one of a storm, a cyclone, a tornado, a flood, fire, hail, a freeze, an earthquake, lightning, explosion, drought, contamination, pollution, theft, disease, pest damage, casualty events, and vandalism.

21. The method of claim 1, wherein the eligible event is included in at least one of a plurality of event classes based on the determined risk-of-loss to the object attributable to the eligible event.

22. The method of claim 21, wherein the determining the cost of the indemnity against the loss to the object from the eligible event over the time period is based on the at least one of the event classes in which the eligible event is included.

23. The method of claim 1, wherein the indemnity against the loss to the object is based on a cost to replace the object when the loss from the eligible event is a total loss, and one of a cost to recondition the object and an amount of diminished value of the object when the loss from the eligible event is a partial loss.

24. The method of claim 23, wherein each of the cost to replace, the cost to recondition, and the amount of diminished value is based on at least one of a material cost of the object at the time of the loss, an installation cost of the object at the time of the loss, an appraised value based on an appraisal of the object at the time of the loss, and a calculated value based on the determined change in the value of the object over the period of time.

25. The method of claim 23, wherein the indemnity is based on a percentage of one of the cost to replace the object, the cost to recondition the object, and the amount of diminished value of the object.

26. The method of claim 25, wherein the indemnity is based on the percentage of the one of the cost to replace the object, the cost to recondition the object, and the amount of diminished value of the object minus a deductible cost.

27. The method of claim 23, comprising:
adjusting the indemnity based on an availability following an occurrence of the eligible event of at least one of a replacement for the object, labor to replace the object, and labor to recondition the object.

28. The method of claim 23, wherein when the indemnity is based the cost to recondition the object, the method comprises:
adjusting the indemnity based on an amount of natural restoration of the object prior to a reconditioning of the object.

29. The method of claim 23, comprising:
adjusting the indemnity based on a value of property associated with the landscape architectural object.

30. The method of claim 23, comprising:
adjusting the indemnity based on a total value of a plurality of landscape architectural objects as included in a landscape architectural setting associated with the object.

31. The method of claim 30, comprising:
adjusting the indemnity based on a total value of a plurality of landscape architectural objects of an object type related to the landscape architectural object as included in the landscape architectural setting.

32. The method of claim 1, wherein the cost of the indemnity against the loss to the object from the eligible event over the time period is based on the following equation:
$${C}_{I} = {\int }_{t = {t}_{1}}^{t = {t}_{2}} V ( t ) \times {R}_{E} ( t ) ⅆ t + {C}_{A} ;$$
wherein: C_{I} is the cost of the indemnity against the loss to the object from the eligible event over the time period (t₂-t₁);
V(t) represents the change in the value of object over the time period;
R(t) represents the risk-of-loss to the object attributable to the eligible event E that can occur over the period;
dt represents a portion of the period; and
C_{A} represents a cost associated with administering the indemnity over the period.

33. The method of claim 32, wherein the cost C_{I} represents a cost to underwrite the indemnity.

34. The method of claim 33, wherein a consumer cost of the indemnity C_{CI} includes the cost of the indemnity C_{I} plus a cost associated with marketing the indemnity C_{MI}.

35. The method of claim 34, comprising:
adjusting the consumer cost of the indemnity C_{CI} based on an implementation of a developmental program associated with a development of the landscape architectural object in a landscape architectural setting.

36. The method of claim 35, wherein the developmental program addresses at least one of a disease susceptibility, an insect damage susceptibility, a flood tolerance, a drought tolerance, a fire tolerance, a heat tolerance, a frost tolerance, a wind tolerance, an impact tolerance, a transplantability, a brittleness, a hail tolerance, a hardiness relative to a geographic location, a height, a maturity, a spread, a basal width, a container size, a lifespan, a soil adaptability, an anaerobic capacity, a pollution tolerance, an irrigation requirement, a sunlight requirement, a salinity tolerance, a shade tolerance, a drainage requirement, a shade-to-sun requirement, an urban tolerance, a form, and a maintenance of the landscape architectural object.

37. The method of claim 35, wherein the developmental program addresses at least one of an elevation, a grade, a stability, a drainage capacity, a proximity to standing or flowing water, an amount of natural or man-made shelter, an accessibility, a proximity to vehicular traffic, a proximity to air traffic, and a proximity to industrial property, a soil type, a density of plantings, a geographic location of the setting, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a soil type, a calcium carbonate (CaCO3) content, an urbanness, a moisture retention factor, an evapotranspiration rate, a relative humidity, and a maintenance of the landscape architectural setting.

38. The method of claim 1, wherein the determining the value associated with the landscape architectural object comprises:
determining regional pricing information associated with at least one of a material cost of the landscape architectural object and an installation cost associated with an installing of the landscape architectural object in a landscape architectural setting.

39. The method of claim 38, wherein the determining regional pricing information comprises:
aggregating pricing information associated with at least one geographic region.

40. The method of claim 38, wherein the regional pricing information is based on at least one of retail regional pricing information and wholesale regional pricing information associated with the at least one of the material cost and the installation cost.

41. The method of claim 38, wherein the retail regional pricing information includes labor rates associated with contracting quotes, government publications, trade associations, industry publications, and affiliated labor contractors associated with the installing of the landscape architectural object in the landscape architectural setting.

42. The method of claim 38, wherein the retail regional pricing information includes information describing a time and a cost per unit of time associated with the installing of the landscape architectural object in the landscape architectural setting.

43. The method of claim 38, wherein the determining the change in the value of the object over the period of time comprises:
determining a change in the at least one of the material cost and the installation cost over the period.

44. The method of claim 43, wherein the determining the change in the at least one of the material cost and the installation cost over the period comprises:
adjusting the regional pricing information associated with the at least one of the material cost and the installation cost over the period based on a macro-economic trend model.

45. The method of claim 43, wherein the change in the material cost associated with the landscape architectural object is based on at least one of a growth rate, a degradation rate, an appreciation rate, and a depreciation rate associated with the object over the time period.

46. The method of claim 45, wherein the at least one of the growth rate, the degradation rate, the appreciation rate, and the depreciation rate is based on at least one of an attribute associated with the landscape architectural object and an attribute associated with the landscape architectural setting.

47. The method of claim 1, wherein the change in the value of the object over the period of time is based on a property value trend model associated with a parcel of land including the landscape architectural object.

48. The method of claim 47, wherein the property value trend model includes at least one of a property sale price, an advertised property price, an insured property value, a property type, a property grade, a lot size, a structure size, a property appraisal, and a property tax assessment value associated with the parcel of land.

49. The method of claim 1, wherein the determining the value associated with the landscape architectural object comprises:
determining a value associated with the landscape architectural object based on an aesthetic contribution of the object to a landscape architectural setting.

50. The method of claim 1, wherein the landscape architectural object includes at least one of a natural and a structural object.

51. The method of claim 50, wherein the natural object includes at least one of earth, rock, water, and a planting.

52. The method of claim 50, wherein the structural object includes at least one of an earthen-structure, an enclosure, a shelter, a specialty building, an engineering structure, an engineering system, a sculptural component, and an outdoor furnishing.

53. A method of adjudicating a claim for a loss to a landscape architectural object, the method comprising:
determining prior to the loss a change in a value associated with the landscape architectural object over a period of time that includes the loss;
determining whether the loss is a total or partial loss to the object; and
paying an amount for the loss based on a cost to replace the object when the loss is a total loss, and one of a cost to recondition the object and an amount of diminished value of the object when the loss is a partial loss;
wherein each of the cost to replace the object, the cost to recondition the object, and the amount of diminished value of the object is based on at least one of a material cost of the object at the time of the loss, an installation cost of the object at the time of the loss, an appraised value based on an appraisal of the object at the time of the loss, and a calculated value based on the determined change in the value of the object over the period of time.

54. The method of claim 53, wherein a percentage of one of the cost to replace the object, the cost to recondition the object, and the amount of diminished value of the object is paid for the loss.

55. The method of claim 54, wherein the percentage of the one of the cost to replace the object, the cost to recondition the object, and the amount of diminished value of the object minus a deductible cost is paid for the loss.

56. The method of claim 53, comprising:
adjusting the amount paid for the loss based on an availability following the loss of at least one of a replacement for the object, labor to replace the object, and labor to recondition the object.

57. The method of claim 53, wherein when the amount paid for the loss is based the cost to recondition the object, the method comprises:
adjusting the amount paid for the loss based on an amount of natural restoration of the object prior to a reconditioning of the object.

58. The method of claim 53, comprising:
adjusting the amount paid for the loss based on a value of property associated with the landscape architectural object.

59. The method of claim 53, comprising:
adjusting the amount paid for the loss based on a total value of a plurality of landscape architectural objects as included in a landscape architectural setting associated with the object.

60. The method of claim 59, comprising:
adjusting the amount paid for the loss based on a total value of a plurality of landscape architectural objects of an object type related to the landscape architectural object as included in the landscape architectural setting.

61. The method of claim 53, wherein the determining prior to the loss the change in the value associated with the landscape architectural object comprises:
determining prior to the loss regional pricing information associated with at least one of an initial material cost of the landscape architectural object and an initial installation cost associated with an installing of the landscape architectural object in a landscape architectural setting.

62. The method of claim 61, wherein the determining prior to the loss the change in the value associated with the landscape architectural object comprises:
determining a change over the period in the regional pricing information associated with the at least one of the initial material cost and the initial installation cost determined prior to the loss.

63. The method of claim 62, wherein the determining the change over the period in the regional pricing information comprises:
adjusting the regional pricing information associated with the at least one of the initial material cost and the initial installation cost determined prior to the loss based on a macro-economic trend model.

64. The method of claim 53, wherein the determining prior to the loss the change in the value associated with the landscape architectural object is based on at least one of a growth rate, a degradation rate, an appreciation rate, and a depreciation rate associated with the object over the time period.

65. The method of claim 64, wherein the at least one of the growth rate, the degradation rate, the appreciation rate, and the depreciation rate is based on at least one of an attribute associated with the landscape architectural object and an attribute associated with the landscape architectural setting.

66. The method of claim 53, comprising:
sending an appraiser to a location of the loss to determine whether the loss is a total or partial loss to the object.

67. The method of claim 66, comprising:
making available to the appraiser at least one of the material cost of the object at the time of the loss, the installation cost of the object at the time of the loss, the cost to recondition the object at the time of the loss, the appraised value of the value of the object at the time of the loss, the amount of diminished value of the object from the loss, and the calculated value of the object based on the change in the value associated with the object over the period of time.

68. The method of claim 67, wherein the at least one of the material cost and the installation cost of the object is based on a real-time regional pricing model.

69. The method of claim 66, comprising:
identifying a standard for valuing the landscape architectural object;
identifying a standard for inspecting the landscape architectural object;
creating a certified appraisal associated with the landscape architectural object based on the identified standard for valuing; and
creating a certified inspection report associated with the landscape architectural object based on the identified standard for inspecting.

70. The method of claim 69, wherein the appraiser is certified to determine the at least one of the cost to recondition the object at the time of the loss, the appraised value of the object at the time of the loss, the amount of diminished value of the object from the loss, and the calculated value of the object based on the change in the value associated with the object over the period of time based on the certified appraisal and certified inspection report.

71. The method of claim 53, comprising:
receiving a claim for the loss of the landscape architectural object;
offering a settlement for the loss based on at least one of the material cost of the object at the time of the loss, the installation cost of the object at the time of the loss, and the calculated value based on the determined change in the value of the object over the period of time;
paying the settlement for the loss when the settlement offered is accepted; and
sending an appraiser to a location of the loss to determine the at least one of the cost to replace the object, the cost to recondition the object, and the amount of diminished value of the object when the settlement offered is rejected.

72. The method of claim 71, wherein the settlement is based on a greater of the material cost plus the installation cost and the calculated value based on the determined change in the value of the object over the period of time.

73. A system for insuring landscape architectural objects, comprising:
a data model; and
a processor coupled to the data model, the processor including:
logic configured to determine a value associated with a landscape architectural object based on information included in the data model;
logic configured to determine a change in the value of the object over a period of time based on information included in the data model;
logic configured to determine a risk-of-loss to the object attributable to an eligible event that can occur over the time period based on information included in the data model; and
logic configured to determine a cost of an indemnity against a loss to the object from the eligible event over the time period based on the change in value and the risk-of-loss.

74. The system of claim 73, wherein the logic configured to determine the value associated with the landscape architectural object comprises:
logic configured to determine regional pricing information associated with at least one of an initial material cost of the landscape architectural object and an initial installation cost associated with an installing of the landscape architectural object in a landscape architectural setting included in the data model.

75. The system of claim 74, wherein the logic configured to determine the change in the value of the object over the period of time comprises:
logic configured to determine a change over the period in the regional pricing information associated with the at least one of the initial material cost and the initial installation cost determined prior to the loss.

76. The system of claim 75, wherein the logic configured to determine the change over the period in the regional pricing information comprises:
logic configured to adjust the regional pricing information associated with the at least one of the initial material cost and the initial installation cost determined prior to the loss based on at least one of a macro-economic trend model and a property value trend model included in the data model.

77. The system of claim 73, wherein the logic configured to determine the change in the value of the object over the period of time comprises:
logic configured to determine at least one of a growth rate, a degradation rate, an appreciation rate, and a depreciation rate associated with the object over the time period.

78. The system of claim 77, wherein the at least one of the growth rate, the degradation rate, the appreciation rate, and the depreciation rate is based on at least one of an attribute associated with the landscape architectural object and an attribute associated with the landscape architectural setting included in the data model.

79. The system of claim 73, wherein the logic configured to determine the risk-of-loss to the object comprises:
logic configured to determine a susceptibility-of-loss to the landscape architectural object from the eligible event.

80. The system of claim 79, wherein the susceptibility-of-loss is based on at least one of an attribute of the landscape architectural object and an attribute of a landscape architectural setting associated with the object included in the data model.

81. The system of claim 80, wherein the logic configured to determine the susceptibility-of-loss comprises:
logic configured to determine at least one of a growth rate and a degradation rate associated with the landscape architectural object based on the at least one of the attribute of the landscape architectural object and the attribute of a landscape architectural setting associated with the object included in the data model.

82. The system of claim 73, wherein the risk-of-loss to the object is based on at least one of frequency-of-loss information related to a prior loss from an event occurring before the eligible event and of an event type related to the eligible event, severity-of-loss information related to the prior loss, and an event trend model included in the data model.

83. The system of claim 82, wherein the at least one of the frequency-of-loss and severity-of-loss information related to the prior loss is associated with at least one of the landscape architectural object and property associated with the object.

84. The system of claim 73, wherein the logic configured to determine the cost of the indemnity against the loss to the object from the eligible event over the time period calculates following equation:
$${C}_{I} = {\int }_{t = {t}_{1}}^{t = {t}_{2}} V ( t ) \times {R}_{E} ( t ) ⅆ t + {C}_{A} ;$$
wherein: C_{I} is the cost of the indemnity against the loss to the object from the eligible event over the time period (t₂-t₁);
V(t) represents the change in the value of object over the time period;
R(t) represents the risk-of-loss to the object attributable to the eligible event E that can occur over the period;
dt represents a portion of the period; and
CA represents a cost associated with administering the indemnity over the period.

85. The system of claim 73, comprising:
logic configured to receive a claim for the loss of the landscape architectural object;
logic configured to determine whether the loss is a total or partial loss to the object based on information included in the claim;
logic configured to offer a settlement for the loss based on at least one of a cost to replace the object when the loss is a total loss, and one of a cost to recondition the object and an amount of diminished value of the object when the loss is a partial loss; and
logic configured to pay the settlement for the loss when the settlement offered is accepted.

86. The system of claim 85, wherein each of the cost to replace the object, the cost to recondition the object, and the amount of diminished value of the object is based on at least one of a material cost of the object at the time of the loss included in the data model, an installation cost of the object at the time of the loss included in the data model, and a calculated value based on the determined change in the value of the object over the period of time.

87. The system of claim 85, comprising:
logic configured to dispatch an appraiser to a location of the loss to determine the at least one of the cost to replace the object, the cost to recondition the object, and the amount of diminished value of the object when the settlement offered is rejected.

88. The system of claim 85, comprising:
logic configured to determine a veracity of the claim based the information included in the claim; and
logic configured to dispatch an appraiser to a location of the loss to verify whether the loss to the object is a total or partial loss when the veracity of the claim is uncertain.

89. A computer readable medium containing a computer program for insuring landscape architectural objects, wherein the computer program comprises executable instructions for:
determining a value associated with a landscape architectural object;
determining a change in the value of the object over a period of time;
determining a risk-of-loss to the object attributable to an eligible event that can occur over the time period; and
determining a cost of an indemnity against a loss to the object from the eligible event over the time period based on the change in value and the risk-of-loss.

90. The computer readable medium of claim 89, wherein the computer program comprises executable instructions for:
determining regional pricing information associated with at least one of an initial material cost of the landscape architectural object and an initial installation cost associated with an installing of the landscape architectural object in a landscape architectural setting.

91. The computer readable medium of claim 90, wherein the computer program comprises executable instructions for:
determining a change over the period in the regional pricing information associated with the at least one of the initial material cost and the initial installation cost determined prior to the loss.

92. The computer readable medium of claim 91, wherein the computer program comprises executable instructions for:
adjusting the regional pricing information associated with the at least one of the initial material cost and the initial installation cost determined prior to the loss based on at least one of a macro-economic trend model and a property value trend model.

93. The computer readable medium of claim 89, wherein the computer program comprises executable instructions for:
determining at least one of a growth rate, a degradation rate, an appreciation rate, and a depreciation rate associated with the object over the time period based on at least one of the attribute of the landscape architectural object and an attribute of a landscape architectural setting associated with the object.

94. The computer readable medium of claim 89, wherein the computer program comprises executable instructions for:
determining a susceptibility-of-loss to the landscape architectural object from the eligible event.

95. The computer readable medium of claim 89, wherein the computer program comprises executable instructions for determining:
$${C}_{I} = {\int }_{t = {t}_{1}}^{t = {t}_{2}} V ( t ) \times {R}_{E} ( t ) ⅆ t + {C}_{A} ;$$
wherein: C_{I} is the cost of the indemnity against the loss to the object from the eligible event over the time period (t₂-t₁);
V(t) represents the change in the value of object over the time period;
R(t) represents the risk-of-loss to the object attributable to the eligible event E that can occur over the period;
dt represents a portion of the period; and
C_{A} represents a cost associated with administering the indemnity over the period.

96. The computer readable medium of claim 89, wherein the computer program comprises executable instructions for:
receiving a claim for the loss of the landscape architectural object;
determining whether the loss is a total or partial loss to the object based on information included in the claim;
offering a settlement for the loss based on at least one of a cost to replace the object when the loss is a total loss, and one of a cost to recondition the object and an amount of diminished value of the object when the loss is a partial loss; and
paying the settlement for the loss when the settlement offered is accepted.

97. The computer readable medium of claim 96, wherein the computer program comprises executable instructions for:
dispatching an appraiser to a location of the loss to determine the at least one of the cost to replace the object, the cost to recondition the object, and the amount of diminished value of the object when the settlement offered is rejected.

98. The computer readable medium of claim 96, wherein the computer program comprises executable instructions for:
determining a veracity of the claim based the information included in the claim; and
dispatching an appraiser to a location of the loss to verify whether the loss to the object is a total or partial loss when the veracity of the claim is uncertain.
